(19) United States
(12) Patent Application Publication
(10) Pub. No.: US 2002/0094206 A1
(43) Pub. Date: Jul. 18, 2002

(54) Image outputting apparatus and apparatus administrating system

(75) Inventors: Takashi Igarashi, Tokyo (JP); Hiroyuki Iizuka, Tokyo (JP); Yasuo Ohkoshi, Tokyo (JP); Hideaki Yamamoto, Tokyo (JP); Takao Tsuda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/014,108

(22) Filed: Nov. 13, 2001

(30) Foreign Application Priority Data
Nov. 17, 2000 (JP) 350581/2000

(51) Int. Cl. G03G 15/00

(52) U.S. Cl. 399/8

(57) ABSTRACT

In an apparatus administrating system, transmission and receipt are possible between at least one image outputting apparatus and an administrating apparatus that conducts maintenance administration for the image outputting apparatus mutually, each function and each unit both necessary for operating the image outputting apparatus are controlled on a unification basis, the administrating apparatus acquires information about the functions and units of the image outputting apparatus through transmission and receipt, and software of plural image outputting apparatuses capable of operating under appropriate conditions including the image outputting apparatus are updated as occasion demands.

### BACKGROUND OF THE INVENTION

The present invention relates to an image outputting apparatus that is installed in a store, an office or a hospital, and to an apparatus administrating system capable of performing transmitting and receiving with an administrating apparatus that conducts maintenance administration for the image outputting apparatus.

The image outputting apparatus includes a photographic printing machine that prints a photograph on a photographic paper from a negative film, for example, and a printmaking apparatus wherein an exposed film is subjected to photographic processing, and a photograph is printed on a photographic paper from the negative film obtained through the photographic processing. However, the image outputting apparatus mentioned here is not limited to the so-called photographic printing apparatus, but it includes an image processing apparatus which processes and composes an image and a means to record as processing including thermal recording that records various images, recording such as ink jet recording, and recording such as electrophotography.

In the image outputting apparatus of this kind, there are provided, for example, a film scanner unit, an exposure unit and a developing unit, and for these units, film scanner unit control, exposure unit control and developing unit control are respectively conducted by each separate software.

In the image outputting apparatus of this kind, the of this kind, if each of the film scanner unit, the exposure unit and the developing unit is sometimes upgraded independently, or if a software is upgraded to a higher version separately, there are sometimes caused troubles on the image outputting apparatus.

In the case of this kind, even when a user calls a service engineer and solves the troubles by himself based on the instruction of the service engineer, or even when a service engineer visits the actual spot and solves the troubles of the image outputting apparatus, when it is difficult to take actions through a telephone alone, there still is a risk that the same troubles are caused again, or a situation where troubles cannot be solved is brought about.

The invention has been achieved in view of the aforesaid points, and its first object is to provide an apparatus administrating system wherein a software can be updated as occasion demands, based on information of each function and unit of the image outputting apparatus.

Incidentally, an image outputting apparatus is installed in a mini-lab, a medical facility or a printing office, and specifications of this image outputting apparatus vary in many cases depending on each user or on each apparatus. Further, setting of the image outputting apparatus also varies in many cases depending on a difference of meteorological conditions of the area for installation.

Therefore, maintenance of the image outputting apparatus must reflects circumstances of each user or of each apparatus and meteorological conditions of an area for installation, which is extremely complicated.

Further, on the image outputting apparatus itself or on each unit provided on the image outputting apparatus, a software matched to each unit needs to be installed, and then, a difference is caused between an old software version and the updated software version, because of option setting by a user after installation or of an agreement of function upgrading, and collision with operations controlled by another software and troubles are caused, resulting in the so-called version partial paralysis.

However, in the past, version information groups representing information relating to serial number of each unit and to version information of software which are provided on the image outputting apparatus in the minilab have not been put in order, or nothing was indicated on the image outputting apparatus except version information of a serial number of each usable unit and a software, which has made it difficult to learn before visiting a location of installation of the image outputting apparatus to be subjected to maintenance.

Therefore, there has been uselessness that a person who conducts maintenance is required to procure necessary units and software before visiting the installation location of the image outputting apparatus again.

In this case, if it is possible to be aware of constituent information representing information including a serial number of a unit provided on the image outputting apparatus and information of a version of a software, in advance, efficiency of maintenance can be improved.

The invention has been achieved in view of these circumstances, and its second object is to provide an image outputting apparatus administrating system which can improve efficiency of maintenance.

Further, there exist a difference of an order tendency between an owner and a requester who outputs a photograph, a medical image and a printed image by using an image outputting apparatus, and a difference of version between a new type and an old type of each unit of an image inputting apparatus or of an image outputting apparatus (image processing apparatus) and between applications used.

Therefore, circumstances of each user need to be reflected on maintenance for a minilab and an image processing apparatus such as a printer for medical images, which has been a complicated work.

The invention has been achieved in view of these circumstances, and its third object is to provide an image outputting apparatus administrating system which makes it possible to conduct maintenance wherein the structure of each image outputting apparatus and error history up to the present time of the image outputting apparatus are taken into consideration, when conducting remote maintenance of an image outputting apparatus such as a minilab.

### SUMMARY OF THE INVENTION

The first object stated above can be attained by the following Structures (1)-(5).

Structure (1)

An apparatus administrating system wherein it is possible to conduct transmitting and receiving between at least one image processing apparatus and an administrating apparatus that conducts maintenance administration for the image processing apparatus, each function and unit necessary for operating the image processing apparatus are administrated integrally through communication between the administrating apparatus and the image processing apparatus, and with respect to updating of software for conducting operation control of each function and unit of the image processing apparatus, the administrating apparatus obtains information of the function and unit of the image processing apparatus, and it is possible to update software of a plurality of image processing apparatuses capable of being moved under the appropriate condition including the image processing apparatus as occasion demands.

In the Structure (1), the administrating apparatus obtains information of function and unit of the image processing apparatus through transmitting and receiving, then, the information is analyzed on the administrating apparatus side, then, mutual relation between each function and unit on each image processing apparatus and thereby there is judged whether the problem is specific or it depends on combination, and when it is judged to be dependent on each function and unit, that combination is judged to be incorrect, and it is possible to change to the combination of version corrected so that normal operation may be conducted by updating of software, after confirming whether those registered on maintenance are not problematic or not and after collecting and confirming information of the image processing apparatus that is driven actually.

Structure (2)

An apparatus administrating system wherein it is possible to conduct transmitting and receiving between at least one image processing apparatus and an administrating apparatus that conducts maintenance administration for the image processing apparatus, each function and unit necessary for operating the image processing apparatus are judged in terms of abnormality based on information about operation of the image processing apparatus accumulated in the image processing apparatus, and with respect to updating of software for conducting operation control of each function and unit of the image processing apparatus through communication between the administrating apparatus and the image processing apparatus, the administrating apparatus obtains information about a function and unit of the image processing apparatus through transmitting and receiving, and it is possible to update software of a plurality of image processing apparatuses capable of being moved under the appropriate condition including the image processing apparatus as occasion demands.

In the Structure (2), information concerning information about abnormality caused in the image processing apparatus is accumulated, then, analyses are made including frequent generation of the same abnormality based on information of operation of the image processing apparatus accumulated in the image processing apparatus, then, each function and unit necessary for operating the image processing apparatus are judged in terms of abnormality, and a request for evasion from the situation by abnormality is made to the administrating apparatus side, and thereby it is possible to change the combination of version corrected so that normal operations may be conducted by updating of the software.

Structure (3)

The apparatus administrating system described in (1) or (2) wherein information which is obtained from the image processing apparatus can be accumulated in a storage device of the administrating apparatus.

In the Structure (3), information which is obtained from the image processing apparatus can be accumulated in a storage device of the administrating apparatus, and thereby, it is possible to update software for a plurality of image processing apparatuses as occasion demands, based on accumulation information on the administrating apparatus side.

Structure (4)

The apparatus administrating system described in (1) or (2) wherein information based on the accumulation information is available from the image processing apparatus.

In the Structure (4), information based on the accumulation information is available from the image processing apparatus, and analyses can be made including frequent generation of the same abnormality by using accumulation information on the image processing apparatus side.

Structure (5)

The apparatus administrating system described in either one of (1)-(4) wherein each of the functions and units of the image processing apparatus is given a specific symbol which makes it possible to distinguish.

In the Structure (5), each of the functions and units of the image processing apparatus is given a specific symbol which makes it possible to distinguish, and the specific symbol indicates the function shown by each unit for each unit, and it is possible to change to a combination of the version corrected so that normal operations may be conducted by updating of software, by using the specific symbol and a serial number in combination.

The second object stated above can be attained by the following Structures (6)-(8).

In Structure (6), a monitoring center having a function to work as the administrating apparatus is connected with an image outputting apparatus having a plurality of units through a network, and in an image outputting apparatus administrating system wherein the image outputting apparatus is administrated by the in the memory 220b of the control unit 220 to be controlled, the image outputting apparatus has a function to send information about structure of a plurality of units to the monitoring center, and the monitoring center has a function to judge compatibility between the image outputting apparatus and units and compatibility between plural units, based on information of structure of the image outputting apparatus. By judging compatibility between the image outputting apparatus and units and compatibility between plural units based on information of structure as stated above, efficiency of maintenance can be improved.

This information of structure includes a serial number of each unit and an installed software version, and can judge compatibility between units, compatibility between software and compatibility between each unit and software.

The image outputting apparatus transmits the information of structure to the monitoring center (or a control center) when connected to the network, or transmits the information of structure to the monitoring center to comply with a request from the monitoring center, or at regular intervals, or as occasion demands, and thereby, it can judge compatibility at appropriate times.

Further, when compatibility of the image outputting apparatus or of software version of each unit is not kept, the monitoring center can download the software version that is appropriate for the condition of the image outputting apparatus or of each unit to the image outputting apparatus or each unit for which compatibility is not kept, to conduct maintenance automatically.

In addition, when compatibility in terms of structure is not kept for the image outputting apparatus or each unit, the monitoring center notifies that to the image outputting apparatus or each unit. Further, in addition to notifying that to the image outputting apparatus or each unit, the monitoring center selects an appropriate structure and notifies it.

In Structure (7), the image outputting apparatus has a function to transmit to the monitoring center the structure information including specific ID information corresponding to the software installed in the image outputting apparatus or information to specify an preparer and version information, in the image outputting apparatus administrating system, and the image outputting apparatus can be structured so that it may have a function to judge compatibility with the image outputting apparatus, based on structure information from the image outputting apparatus, thereby, compatibility in software or compatibility between each unit and software is judged.

In Structure (8), the image outputting apparatus has a function to transmit to the monitoring center the structure information including specific ID information corresponding to a plurality of units or to a plurality of software or information to specify an preparer and version information, in the image outputting apparatus administrating system, and the image outputting apparatus has a function to judge whether each unit or each software is conformed or each unit and each software are mutually conformed based on structure information from the image outputting apparatus, thereby, a unit or a software of the image outputting apparatus is switched or automatic version is changed, based on the judgment.

The third object stated above can be attained by the following Structure (9).

In Structure (9), a monitoring center is connected with an image outputting apparatus through a network, and in an image outputting apparatus administrating system wherein the image outputting apparatus is administrated by the monitoring center, the image outputting apparatus has a memory to store error log information, and the monitoring center judges whether troubles are caused on the image outputting apparatus or not, based on the error log information obtained from the image outputting apparatus. Owing to that the monitoring center judges whether troubles are caused on the image outputting apparatus or not, based on the error log information, it is possible to conduct maintenance wherein structure of each image outputting apparatus and history of errors in the image outputting apparatus up to the present time are taken into consideration.

Further, the monitoring center can change, modify, correct or upgrade a version the control soft in the image outputting apparatus based on the error log information, and thereby carry out remote maintenance.

It is possible for the image outputting apparatus to transmit in compliance with a periodical request by the monitoring center for transmitting error log information, and to transmit in compliance with a request by the monitoring center for transmitting error log information in case of need, and thereby to carry out remote maintenance by obtaining erro log information.

Further, the image outputting apparatus may either transmit error log information to the monitoring center periodically in compliance with no request for transmitting, or transmit error log information to the monitoring center as occasion demands, or transmit to the monitoring center at the timing corresponding to data of accumulating contents of error log information.

### BRIEF DESCRIPTION OF THE DRAWINGS

FIG. 1 is a schematic structure diagram of an apparatus administrating system.

FIG. 2 is a perspective view of an image processing apparatus.

FIG. 3 is a schematic structure diagram of the image processing apparatus.

FIG. 4 is a diagram showing a first embodiment of an apparatus administrating system.

FIG. 5 is a diagram showing a second embodiment of an apparatus administrating system.

FIG. 6 is a schematic structure diagram of an image outputting apparatus administrating system.

FIG. 7 is a structural diagram for a monitoring center and an image outputting apparatus.

FIG. 8 is a diagram showing a table of regular combinations of serial numbers, version information and unit constituent parts.

FIG. 9 is a flow chart indicating operations of maintenance.

FIG. 10 is a flow chart indicating periodical inspection operations for error log information.

### DETAILED DESCRIPTION OF THE PREFERRED EMBODIMENT

Referring to the drawings, an embodiment of an apparatus administrating system of the invention will be explained as follows, with respect to an apparatus to record from a photographic negative to a photographic paper, and the invention is not limited to this embodiment. This apparatus administrating system is applied to an apparatus wherein images for medical diagnoses, printing images and design images are processed and recorded, in stores, offices, hospitals and factories.

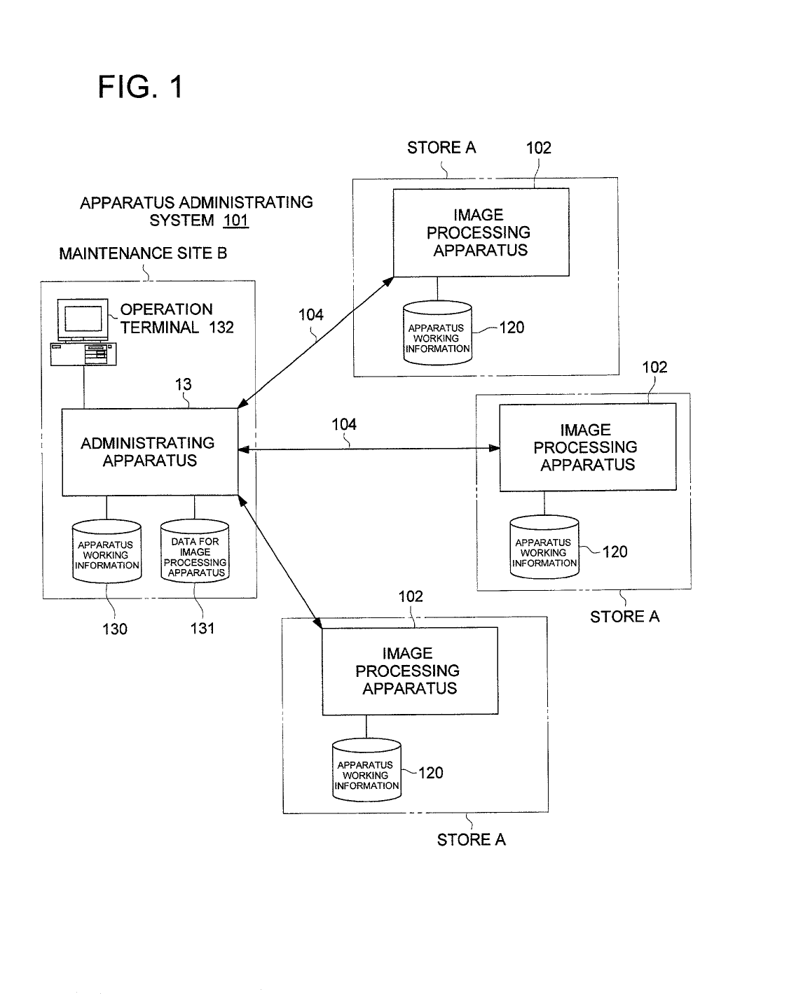

FIG. 1 is a schematic structure diagram of an apparatus administrating system. Apparatus administrating system 101 can transmit and receive information through communication channel (communicating system or network) 104 with image processing apparatus 102 installed in store A or the like and with administrating apparatus 103 installed on a side of maintenance site B that conducts maintenance control for the image processing apparatus 102. As this communication channel 104, a communication network such as an internet and an analog public line are used.

On the administrating apparatus 103, there are provided storage devices 130 and 131, and apparatus operation information obtained from the image processing apparatus is accumulated on the storage device 130, while, data for the image processing apparatus are accumulated on the storage device 131. Further, operation terminal 132 is connected to the administrating apparatus 103 which is operated by the operation from the operation terminal 132, and is capable of communicating with image processing apparatuses 102 installed in a plurality of stores A, and it may also be made possible to communicate with a plurality of image processing apparatuses 102 installed in store A.

The image processing apparatuses 102 includes a photographic printing machine to print a photograph on a photographic paper from a negative film, for example, and a print making apparatus wherein an exposed film is processed photographically, and a photograph is printed on a photographic paper from the processed negative film to be processed photographically, and thereby a print is made, and these photographic printing machine and print making apparatus include also a recording apparatus, an image transmission apparatus and an image storage apparatus. Further, on the image processing apparatuses 102, there is provided storage apparatus 120 on which information of apparatus operation of the image processing apparatus is accumulated.

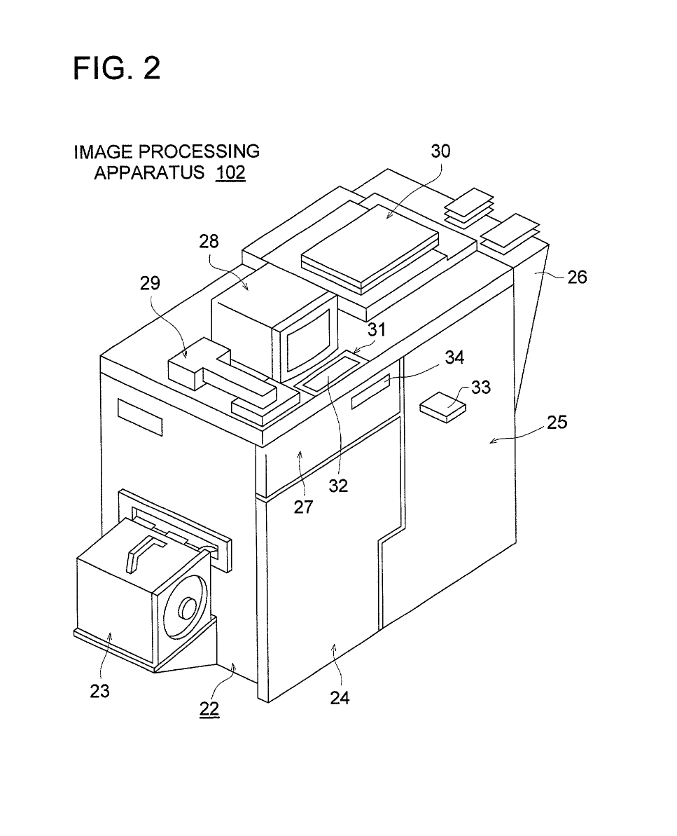

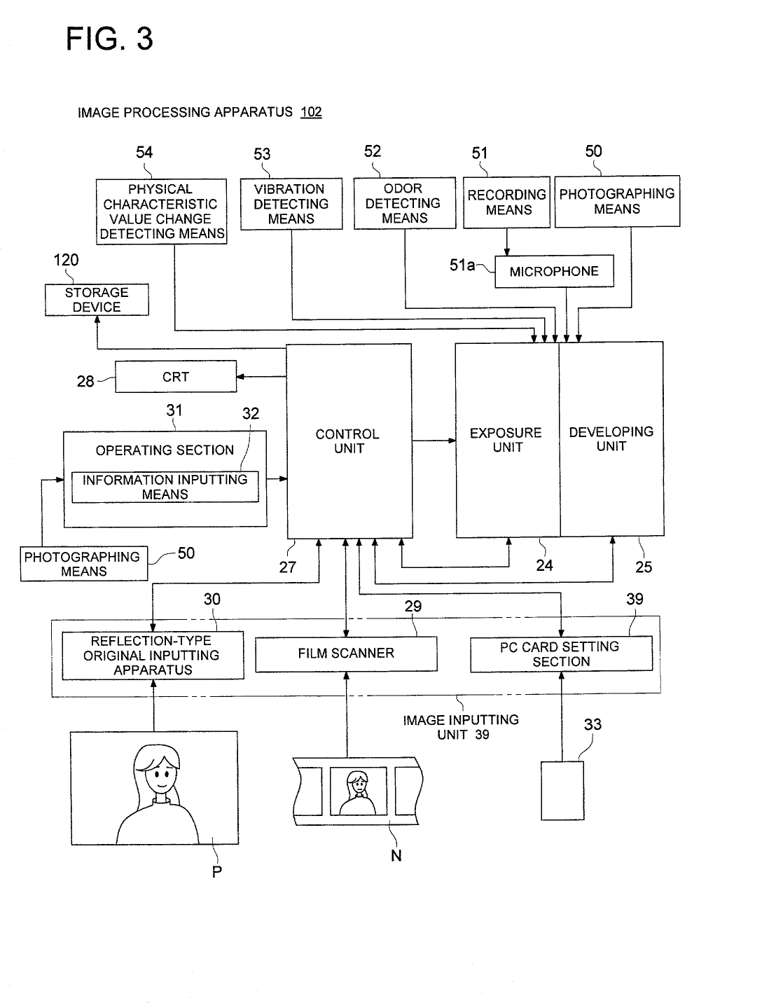

In the present embodiment, the print making apparatus is used as image processing apparatus 102 which is shown in FIG. 2 and FIG. 3.

FIG. 2 is a perspective view of an image processing apparatus, and FIG. 3 is a schematic structure diagram of the image processing apparatus. In these drawings, the image processing apparatus 102 is exemplified to be one wherein a photosensitive material is exposed to light and is developed to be a print. However, the image processing apparatus of the invention is not limited to the foregoing, but it may be anything such as, for example, a print making apparatus of an ink jet system and that of an elelctrophotographic system, provided that it can make a print based on image data.

In the image processing apparatus 102 of the present embodiment, magazine loading section 23 is provided on the left side of apparatus main body 22, and exposure unit 24 that exposes a photosensitive material representing a recording medium and developing unit 25 that processes the exposed photosensitive material photographically and dries it to make a print are provided in the apparatus main body 22, and a print thus made is ejected onto tray 26 provided on the right side of the apparatus main body 22. Further, inside the apparatus main body 22, control unit 27 is provided at the upper position of the exposure unit 24.

On the upper portion of the apparatus main body 22, there is arranged CRT 28. This CRT 28 constitutes a display means that displays, on a screen, an image of image data by which a print is to be made. On the left side of the CRT 28, there is arranged film scanner section 29 representing a transmission-type original reading apparatus, and on the right side thereof, there is arranged reflection-type original inputting apparatus 30.

As an original to be read from the film scanner section 29 or the reflection-type original inputting apparatus 30, there is a photographic photosensitive material, and as this photographic photosensitive material, there are given a color negative film and color reversal film N. A film scanner of the film scanner section 29 can convert into digital information to make it a frame image information. When a photographic photosensitive material is color paper P, a flat bed scanner of reflection-type original inputting apparatus 30 can make it to be frame image information.

At the position of control unit 27 of the apparatus main body 22, there is provided PC card inserting section 34 into which PC card 33 can be inserted, and the PC card 33 has a memory that stores data of images for a plurality of frames picked up by a digital camera. The PC card having a memory that stores frame image data is represented by, for example, a flush ATA card and a compact flush card connected with a PC card adaptor and by smart media, and it constitutes an image data storing medium. Image inputting unit 39 is composed of film scanner section 29, reflection-type original inputting unit 30 and PC card inserting section 34.

In front of CRT 28, there is arranged operation section 31 on which information inputting means 32 is provided, and the information inputting means 32 is structured with, for example, a touch panel.

Incidentally, CRT 28, operation section 31, film scanner section 29, reflection-type original inputting unit 30 and PC card inserting section 34 are provided integrally on apparatus main body 22. However, it is also possible to provide one or more of the aforesaid items as a separate object. In this case, image processing apparatus 102 is used as a print making system.

On the image processing apparatus 102 in the embodiment, there is provided photographing means 50 that photographs the state of operation and the state of movement of the image processing apparatus 102. The state of operation of the operation screen of the operation section 31 is photographed by the photographing means 50, and the state of movements of exposure unit 24 and of developing unit 25 in the image processing apparatus 2 are photographed, and stored in storage apparatus 120 as operation information of the apparatus.

Further, it is also possible for the photographing means 50 to be made movable although it is installed so that it can photograph the prescribed position of the image processing apparatus 102. When the photographing means 50 is movable, an operator photographs locations which are considered by the operator to have abnormality, the state of operation and/or the state of movement of the image processing apparatus 102 are photographed appropriately, and are stored in storage apparatus 120 as operation information of the apparatus.

A video camera that photographs moving images or a CCD camera, for example, is used as the photographing means 50, and it is also possible to arrange so that operation information of the apparatus for the state of operation and/or the state of movement of image processing apparatus 2 may be stored in storage apparatus 120 by means of image information of moving images, and operation information of the apparatus may be obtained by the use of a camera that photographs still images.

Further, on the image processing apparatus 102 in the embodiment, there is provided sound recording means 51 that records a working sound of the image processing apparatus 102. The sound recording means 51 collects sounds and records them.

The working sound information thus recorded is stored in the storage apparatus 120 as operation information of the apparatus.

The sound recording means 51 has microphone 51a as a sound collecting means, and by providing this microphone 51a on each portion such as exposure unit 24 and developing unit 25 of image processing apparatus 102, it is possible to obtain various working sounds of the image processing apparatus 102, and thereby to learn abnormal locations and causes for abnormalities from these various working sounds.

Sensitivity for the wording sound can be controlled by surrounding sounds. Under the standard of a level of an ordinary sound, an abnormal sound can be judged with a sound of gears in the image processing apparatus 102 serving as a reference, for example. Working sounds are usually updated after a period of prescribed time and are erased, and when troubles are caused, working sounds before and after the troubles are saved to be materials for analyses.

With respect to working sounds, it is preferable that each microphone 51a representing a sound collecting means provided on each image processing apparatus 102 is the same as others, and maintenance of efficiency of the microphone is checked by generating the standard sound periodically.

For example, it is possible to make the image processing apparatus 102 to operate on a standard condition the first thing in the morning, and to compare the sound generated in the operation with contents of the standard sound stored in advance, for diagnoses of abnormalities. It is also possible to have a help manual provided and to make the standard sound by making the help manual to generate a sound.

By arranging a plurality of microphones 51a in a way that directions of sound sources for the microphones are not the same, the directions of the sound sources are specified, which can reduce the total number of microphones 51a arranged.

With regard to sound sources located to be away each other in terms of frequency, their directions for microphones 51a can be the same each other.

A sound is one wherein a plurality of frequencies are combined. As a method to separate a sound into frequency components, FFT (fast Fourier transform) is famous. On the other hand, a machine of image processing apparatus 102 is driven by rotating a motor at constant speed, for example. If the rotation is constant in terms of speed, the rotation sound is constant. Therefore, the frequency is constant. When an abnormal sound is generated, there is generated a sound whose frequency is different from an ordinary frequency. Therefore, if the frequency characteristics under the normal condition are stored, the abnormal sound can be detected from a difference of frequencies.

When specifying the direction of the sound source with microphone 51a, it is possible to obtain a stress of a sound having a certain character on each microphone 51a by arranging a plurality of directional microphones 51a in different directions and by comparing frequency components of each microphone 51a and changes in a time series of frequency. By investigating a similarity of frequency distribution between microphones 51a and a stress, the direction of a sound source can be specified.

In addition, on the image processing apparatus 102 in the present embodiment, there is provided a smell detecting means 52 that detects a smell at a prescribed position of image processing apparatus 102. A smell is detected by this smell detecting means 52, and is stored in storage apparatus 120 as operation information of the apparatus.

The smell detecting means 52 can detect smell components sticking to the surface of a semiconductor, for example, and a smell of a processing solution in print making section 25, a smell of a heater of a thermal developing section and a smell of a drying section, for example, can be detected.

Further, on the image processing apparatus 102 in the present embodiment, there is provided vibration detecting means 53 that detects a vibration at the prescribed position on image processing apparatus 102. Information of vibration detected by this vibration detecting means 53 is stored in storage apparatus 120 as operation information of the apparatus.

By storing, in image processing apparatus 102, even the standard time to be used, it is possible to learn abnormal locations and causes for abnormalities when the abnormalities are caused.

The vibration detecting means 53 detects, for example, vibrations of conveyance rollers of exposure unit 24 and of developing unit 25, vibration of a guide plate, vibration of a belt, and vibrations of a developing section of the developing unit 25 and of the drying section. Further, it is easy to analyze causes for abnormalities in the abnormal conditions wherein image processing apparatus 102 is vibrated by the weak floor portion that is out of guarantee in the floor for installation.

On image outputting apparatus 102 of the present embodiment, there is provided physical characteristic value change detection means 54 that detects changes in values of physical characteristics such as heat, light and pressure which are needed for image processing conducted by the image outputting apparatus 102. Heat needed for image processing is represented by heat in a drying section, light needed for image processing is represented by an exposure amount and pressure needed for image processing is represented by pressure of a conveyance means that conveys a photosensitive material. Information of changes in physical characteristic values detected by the physical characteristic value change detection means 54 is stored in storage device 120 as operation information of an apparatus.

By detecting changes in values of physical characteristics such as heat, light and pressure necessary for image processing conducted by image outputting apparatus 102 and by storing information of changes in physical characteristic values in the storage device 120 as operation information of an apparatus as stated above, it is possible to learn abnormal portions in the image outputting apparatus 102 and causes for abnormality, from the information of changes in physical characteristic values. The physical characteristic value change detection means 54 detects changes in values of physical characteristics such as heat, light and pressure which are needed for image processing in the image outputting apparatus 102, and thereby, it is easy to clear up the causes from the relationship with the timing of trouble occurrence, which is the same as in sound.

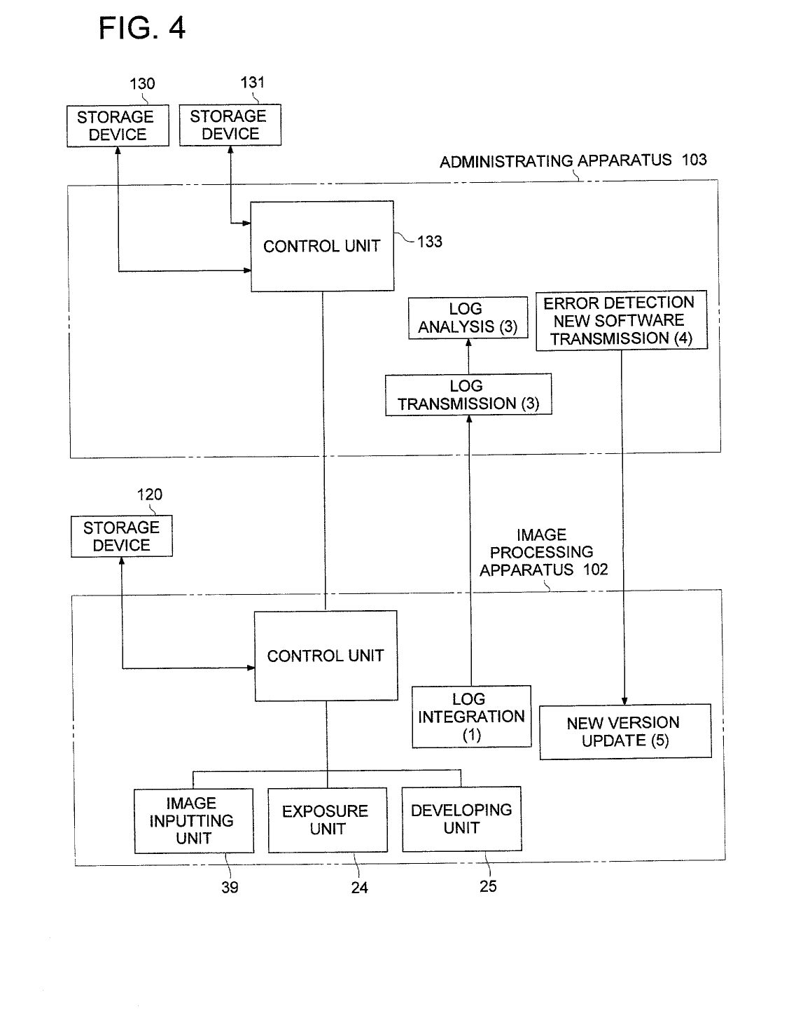

Next, the first embodiment of an apparatus administrating system that attains the first object is shown in FIG. 4.

The apparatus administrating system of the present embodiment makes it possible for the image outputting apparatus 102 and administrating apparatus 103 that administrates maintenance for the image outputting apparatus 102 to transmit and receive each other.

Each of image inputting unit 39, exposure unit 24 and developing unit 25, all in the image outputting apparatus 102 is operated respectively by its own independent software, and control unit 27 is operated by an operation software to be manipulated by an operator. Each of image inputting unit 39, exposure unit 24 and developing unit 25 can be upgraded independently for higher version in terms of unit and software.

Control unit 27 of the image outputting apparatus 102 has an interface for connecting the outside with a network directly or indirectly, and is connected to a server that controls maintenance data collectively through WAN.

As stated above, a communication means is provided on the control unit 27 of the image outputting apparatus 102 and on control unit 133 of the administrating apparatus 103, and each function and unit necessary to operate the image outputting apparatus 102 are controlled collectively by communication between the administrating apparatus 103 and the image outputting apparatus 102.

With regard to updating of software that conducts operation control for each function and unit of the image outputting apparatus 102, apparatus information of each function and unit is log-integrated in storage device 120 of the image outputting apparatus 102, and log transmitting is conducted at control unit 27 to send to control unit 133 of control device 103.

The log in this case is one wherein information showing the operation state of the apparatus is described with time and code, and it is gradually subjected to addition, elimination and updating. Examples of log generated between control unit (CP) and film scanner unit (FS) are shown below.

2000/05/06 00:10:20. 00CP-FS:NT00000

No trouble in communication between CP and FS

2000/05/06 00:10:25. 00CP-FS:WA00001

Warning of code 00001 in communication between CP and FS

2000/05/06 00:10:30. 00CP-FS:SE00001

Serious error of code 00001 in communication between CP and FS

2000/05/06 00:10:30. 00CS-SE00000

Serious error code 00000 in FS unit

The first term represents a date, and next terms represents time (o'clock, minutes, seconds).

The next term represents communication relations, and CP-FS indicates data transmission from the control unit to the film scanner unit. The term after the colon represents the state of the control unit and the film scanner unit such as NT (no trouble), WA (warning), ER (error), and SE (serious error), and a number of five figures in the last term represents the location of occurrence and contents.

For example, it is possible to define so that NT00000 shows no problem, NT00001 shows scanning, NT00002 shows conveyance, WA00001 shows insignificant problem in the course of scanning, ER00001 shows suspension because of serious problem such as jam and SE00001 shows that no signal input under the state of scanning is obtained. Incidentally, depending on the code generated, apparatus troubles can be detected.

The control device 103 obtains information of a function and a unit of the image outputting apparatus 102 through transmitting and receiving, thus, log analyses are conducted at control unit 133, troubles of the function and the unit of the image outputting apparatus 102 are detected, and transmission of new software is conducted. On the control unit 27 of the image outputting apparatus 102, there is conducted command for updating to new software, and a software can be updated as occasion demands.

Namely, the control device 103 obtains information of a function and a unit of the image outputting apparatus 102 through transmitting and receiving, thus, the information is analyzed on the control device 103 side, and mutual relationship between each function and each unit of the image outputting apparatus 102 is checked whether the problem is proper to them or is dependent on the combination of them. When the problem is judged to be dependent on each function and unit, that combination is judged to be wrong, and it is possible to change to another combination of versions corrected so that normal operations may be conducted with updated software, after confirming whether those registered on maintenance are problematic or not and after correcting again information of the image outputting device 102 driven actually and confirming it.

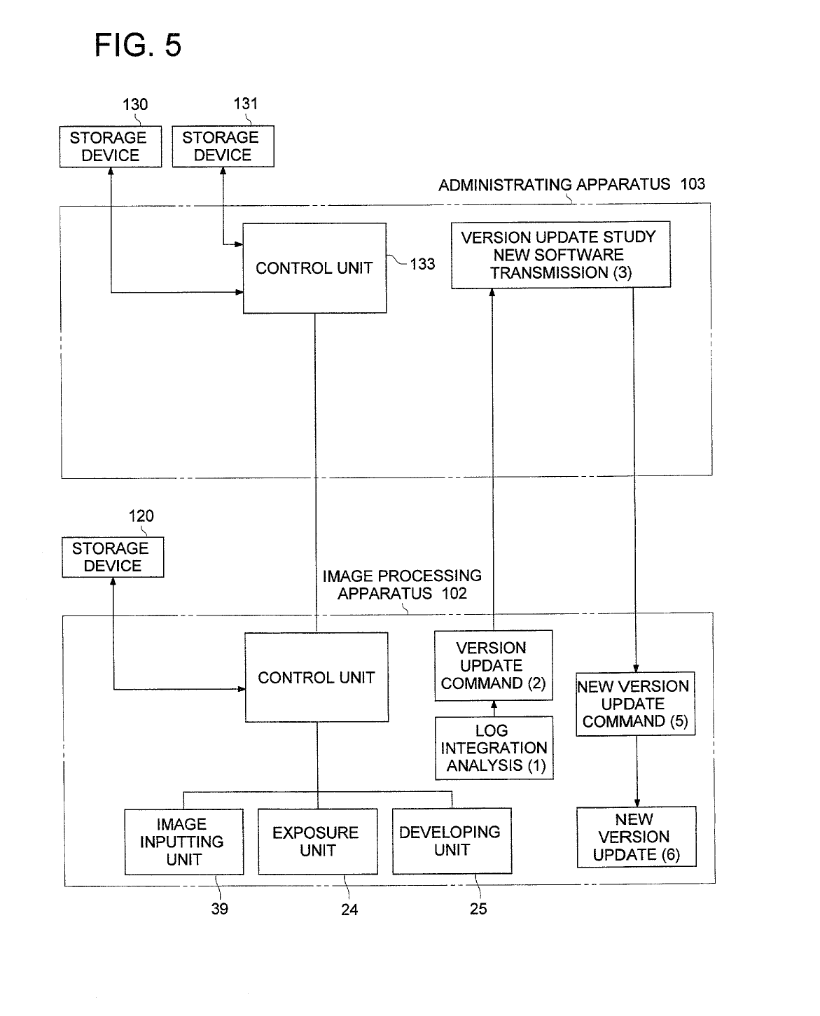

Next, the second embodiment of an apparatus administrating system that attains the first object is shown in FIG. 5.

The apparatus administrating system in the present embodiment can conduct transmitting and receiving between the image outputting apparatus 102 and the control device 103 that conducts maintenance administration for the image outputting apparatus 102, which is the same as in the embodiment shown in FIG. 4.

Troubles in each function and unit which are necessary for operating the image outputting apparatus 102 based on information of operations of the image outputting apparatus 102 accumulated in the image outputting apparatus 102 are judged.

With regard to updating of the software that conducts operation control for each function and unit of the image outputting apparatus 102, apparatus information of each function and unit is log-integrated in storage device 120 of the image outputting apparatus 102, and log analyses are conducted for the log-integration, thus, troubles in functions and units of the image outputting apparatus 102 are detected, and updating to a new version is commanded.

In control unit 133 of the administrating apparatus 103, when a command of updating to a new version is received, updating of the version is studied, and a new software is transmitted.

Control unit 27 of the image outputting apparatus 102 receives the command of updating to a new version and conducts updating of the software for each unit including a control unit as occasion demands.

With respect to updating of a software for conducting operation control for each function and unit of the image outputting apparatus 102 through communication between the control device 103 and the image outputting apparatus 102 as stated above, the control device 103 obtains information of functions and units of the image outputting apparatus 102 through transmitting and receiving, and thereby the software can be updated as occasion demands.

Namely, information relating to information of troubles caused in the image outputting apparatus 102 is accumulated, and analyses are made, including frequent occurrence of the same troubles, based on information of operations of the image outputting apparatus 102 accumulated therein, thereby, troubles of each function and unit which are needed for operating the image outputting apparatus 102 are judged, and avoidance of the situation caused by troubles is requested to the control device side, thus, it is possible to change to another combination of versions corrected so that normal operations may be conducted with updated software.

In these first and second embodiments, information obtained from the image outputting apparatus 102 can be integrated in storage devices 130 and 131 of the control device 103, and thereby, it is possible to update the software for plural image outputting apparatuses 102 as occasion demands, at the control device side, based on the integrated information.

Further, information based on the integrated information is available from the image outputting apparatus 102, and analyses can be made on the image outputting apparatus side by the use of integrated information, including frequent occurrence of the same troubles.

Further, a specific symbol which can be distinguished for each of functions and units of the image outputting apparatus 102 is provided, and the specific symbol indicates clearly a function shown by each unit, and is used in combination with a serial number, thus, it is possible to change to the combination of versions corrected so that normal operations may be conducted with updated software.

Namely, as information for apparatus operations, a serial number is added to the specific information of a unit, which is exemplified as follows.

Film scanner unit

. . . FS000130 (Film Scanner Unit)

Exposure unit

. . . EX000151 (Exposure Unit)

Developing unit

. . . DV100140 (Development Unit)

Control unit

. . . CP200133 (CPU Unit)

The foregoing are unitized, and an apparatus number is given.

As a condition for software, a version number is given, which is exemplified as follows.

Operation software (Control Unit)

. . . 1.30R8

Film scanner unit control

. . . 1.11R3

Exposure unit control

. . . 1.10R2

Developing unit control

. . . 1.20R3

When there is malfunction, combination of the foregoing versions is taken into consideration.

When changing each unit, combination thereof and a targeted function, versions for application used under the present conditions are checked, and then, the combinations of versions is determined.

As stated above, in the Structure (1), the administrating apparatus obtains information of function and unit of the image processing apparatus through transmitting and receiving, then, the information is analyzed on the administrating apparatus side, then, mutual relation between each function and unit on each image processing apparatus and thereby there is judged whether the problem is specific or it depends on combination, and when it is judged to be dependent on each function and unit, that combination is judged to be incorrect, and it is possible to change to the combination of version corrected so that normal operation may be conducted by updating of software, after confirming whether those registered on maintenance are not problematic or not and after collecting and confirming information of the image processing apparatus that is driven actually.

In the Structure (2), information concerning information about abnormality caused in the image processing apparatus is accumulated, then, analyses are made including frequent generation of the same abnormality based on information of operation of the image processing apparatus accumulated in the image processing apparatus, then, each function and unit necessary for operating the image processing apparatus are judged in terms of abnormality, and a request for evasion from the situation by abnormality is made to the administrating apparatus side, and thereby it is possible to change the combination of version corrected so that normal operations may be conducted by updating of the software.

In the Structure (3), information which is obtained from the image processing apparatus can be accumulated in a storage device of the administrating apparatus, and thereby, it is possible to update software for a plurality of image processing apparatuses as occasion demands, based on accumulation information on the administrating apparatus side.

In the Structure (4), information based on the accumulation information is available from the image processing apparatus, and analyses can be made including frequent generation of the same abnormality by using accumulation information on the image processing apparatus side.

In the Structure (5), each of the functions and units of the image processing apparatus is given a specific symbol which makes it possible to distinguish, and the specific symbol indicates the function shown by each unit for each unit, and it is possible to change to a combination of the version corrected so that normal operations may be conducted by updating of software, by using the specific symbol and a serial number in combination.

Next, based on the drawings, there will be explained an embodiment of an image outputting apparatus administrating system attaining the second object, to which, however, the invention is not limited.

Though the image outputting apparatus administrating system of the present embodiment is explained concerning an image outputting apparatus installed in a minilab, it can also be applied likewise to those installed in a medical facility and a printing office, and how to use this image outputting apparatus varies depending on each user or on each apparatus, and setting of the image outputting apparatus varies, in many cases, depending on a difference of meteorological conditions of an area where the image outputting apparatus is installed.

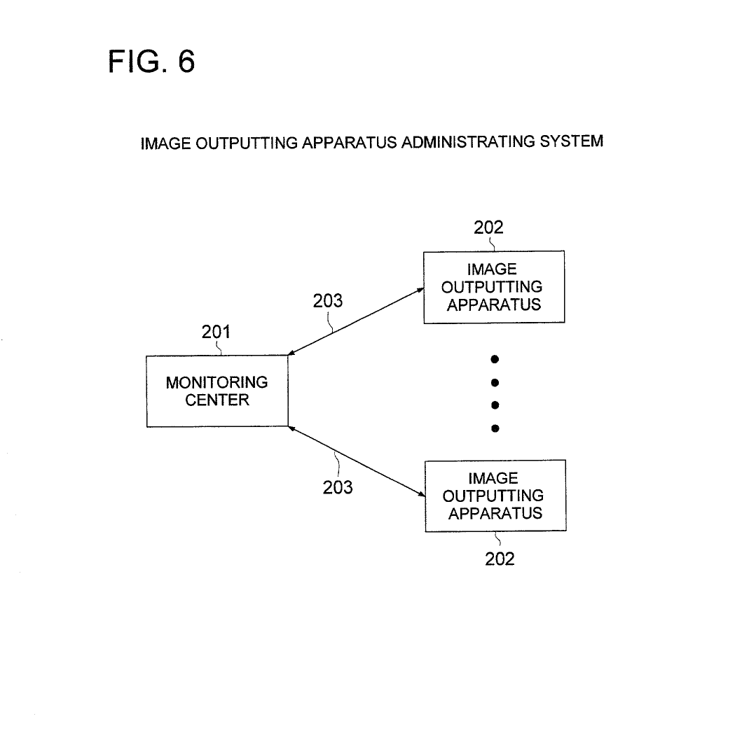

FIG. 6 is a schematic structure diagram of an image outputting apparatus administrating system.

In the image outputting apparatus administrating system of the present embodiment, monitoring center 201 is connected with plural image outputting apparatuses having a plurality of units through a network, and the monitoring center 201 controls plural image outputting apparatuses 202.

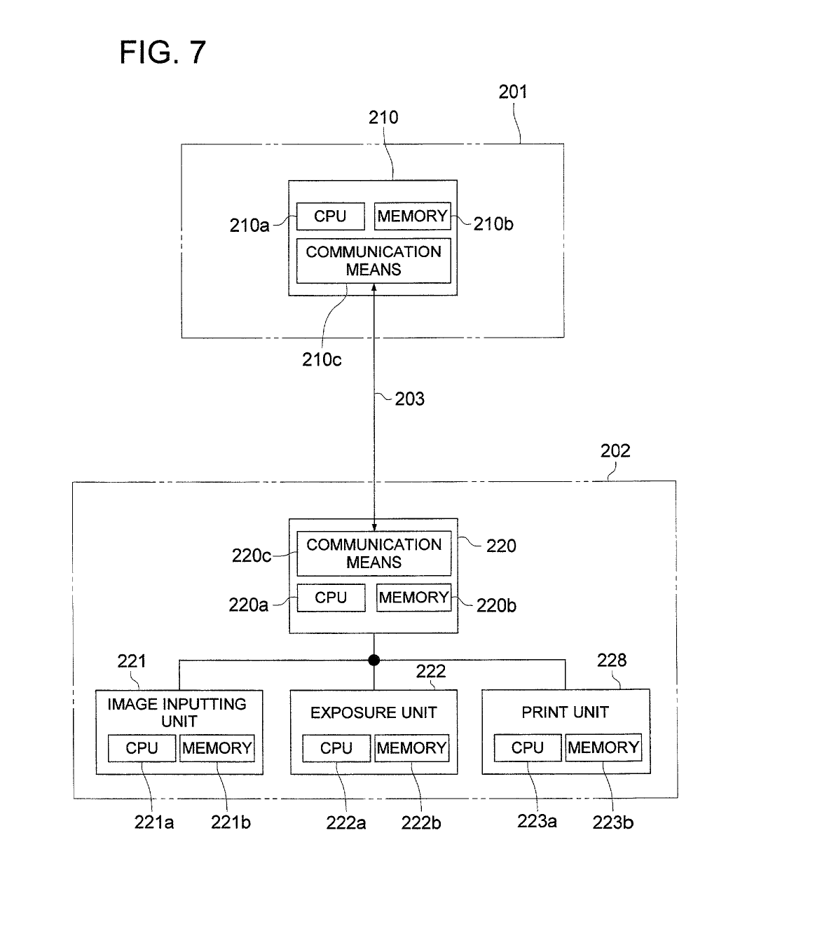

FIG. 7 is a structural diagram for a monitoring center and an image outputting apparatus.

On the image outputting apparatuses 202, there is provided control unit 220 that conducts overall control. The control unit 220 controls operations of image inputting unit 221, exposure unit 222 and print unit 223. The control unit 220 is provided with CPU220a and memory 220b, and a software is installed in the memory 220b, while, CPU220a executes the software to conduct desired operations under the control.

The image inputting unit 221 is provided with CPU221a and memory 221b, while, the exposure unit 222 is provided with CPU222a and memory 222b, and the print unit 223 is provided with CPU223a and memory 223b. A software is installed in each of memories 221b, 222b and 223b, and each of CPUs 221a, 222a and 223a executes the software to conduct desired operations under the control.

In the present embodiment, each of the image inputting unit 221, the exposure unit 222 and the print unit 223 is provided with a CPU and a memory. However, there is also an occasion wherein a CPU and a memory are not provided, and a control is made by a software for total control by means of CPU 220a and memory 220b both provided on the control unit 220.

Further, each of these units is given a serial number which indicates a function of the unit, and this serial number is stored in memory 220b of the control unit 220 to be controlled. Further, version information of the software installed in each unit is also stored in the memory 220b of the control unit 220 to be controlled. Only serial number, or only version information, or both of them may be stored in the memory 220b of the control unit 220 to be controlled.

Further, each unit represents sometimes mechanical parts totally, or each unit includes sometimes electric parts for operations, or it further represents a unit in a form wherein CPU controlling operations as stated above or a memory controlling CPU has a software.

Each of these units is a unit that satisfies prescribed functions when it is shipped to a user from a maker, and its serial number has, as an ID, the function for specifying the unit such as, for example, EXP-L-001-991225-043 (an LED exposure unit in type 001 that is 043^{th} one among those shipped on Dec. 25, 1999), or an exposure unit in type M13 made by ABC Company having No. 0214.

These information may either be stored in monitoring center 201 of image outputting apparatus 202, or be stored in each unit itself mechanically (existence of comb tooth), or be stored in an attached memory. Further, the image outputting apparatus 202 has a function to store a version or a serial number of an integrated unit or a software to make the unit to operate and to make them known in accordance with transmission or access.

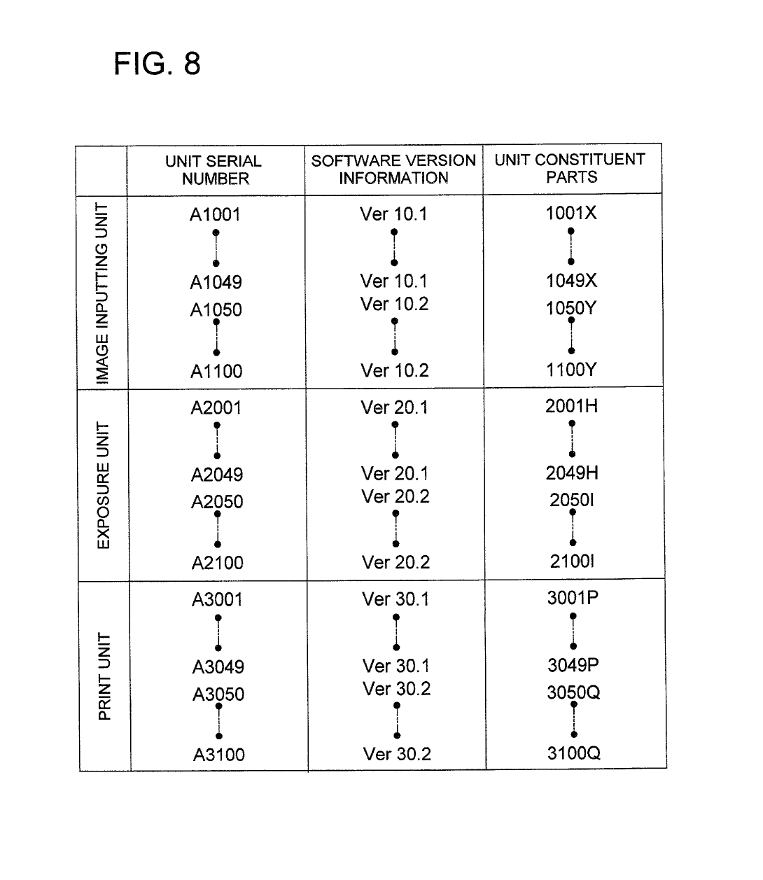

The monitoring center 201 in the embodiment has control unit 210. The control unit 210 is controlled by a software for the total control by CPU 210a and memory 210b. In memory 210b of the monitoring center 201, there is stored, or stored successively a table for regular combination of a serial number and version information. An example of this is shown in FIG. 8.

FIG. 8 is a diagram showing the table for regular combination of a serial number, version information and unit constituent parts, and it shows the serial number, version information and a unit constituent part which correspond to each other, or shows the serial number with which each unit corresponds to another unit.

The symbol “A” in a serial number of each unit in FIG. 8 shows each unit which can be connected to the image outputting apparatus administration system to be administrated.

In the image inputting unit 221, “A1001-A1049” of serial numbers conform to “Ver10.1-Ver10.1” of version information and to “1001X-1049X” of unit constituent parts, while, “A1050-A1100” of serial numbers conform to “Ver10.2-Ver10.2” of version information and to “1050Y-1100Y” of unit constituent parts.

The symbol “X” of unit constituent part shows one equipped with a film scanner, for example, and “Y” shows one which can take in image information even from a storage memory card, for example.

In the exposure unit 222, “A2001-A2049” of serial numbers conform to “Ver20.1-Ver20.1” of version information and to “2001H-2049H” of unit constituent parts, while, “A2050-A2100” of serial numbers conform to “Ver20.2-Ver20.2” of version information and to “2050I-2100I” of unit constituent parts.

The symbol “H” of unit constituent part shows one equipped with an LED exposure, for example, and “I” shows one equipped with a laser exposure, for example.

In print unit 223, “A3001-A3049” of serial numbers conform to “Ver30.1-Ver30.1” of version information and to “3001P-3049P” of unit constituent parts, while, “A3050-A3100” of serial numbers conform to “Ver30.2-Ver30.2” of version information and to “3050Q-3100Q” of unit constituent parts.

The symbol “P” of unit constituent part shows one equipped with a development print, for example, and “Q” shows one equipped with a thermal transfer print, for example.

On control unit 210 of monitoring center 201 and on control unit 220 of image outputting apparatus 202, there are provided communication means 210c and 220c both connected to network 203, and the communication means 210c and 220c are used for communication between the monitoring center 201 and image outputting apparatus 202.

The image outputting apparatus 202 has a function to send structural information of plural units to monitoring center 201, and the monitoring center 201 has a function to judge, based on structural information from image outputting apparatus 202, the compatibility between the image outputting apparatus 202 and the unit or the compatibility for plural units.

If the image outputting apparatus 202 sends structure information to monitoring center 201 when the image outputting apparatus 202 is connected to network 203, compatibility can be judged when the image outputting apparatus 202 is connected to the network 203.

Further, if the image outputting apparatus 202 sends structure information to monitoring center 201 meeting a demand from the monitoring center 201, compatibility can be judged at any time.

In addition, the image outputting apparatus 202 can judge compatibility automatically by sending structure information to the monitoring center 201 periodically.

Further, if the image outputting apparatus 202 sends structure information to monitoring center 201 as occasion demands, compatibility can be judged at appropriate time as occasion demands.

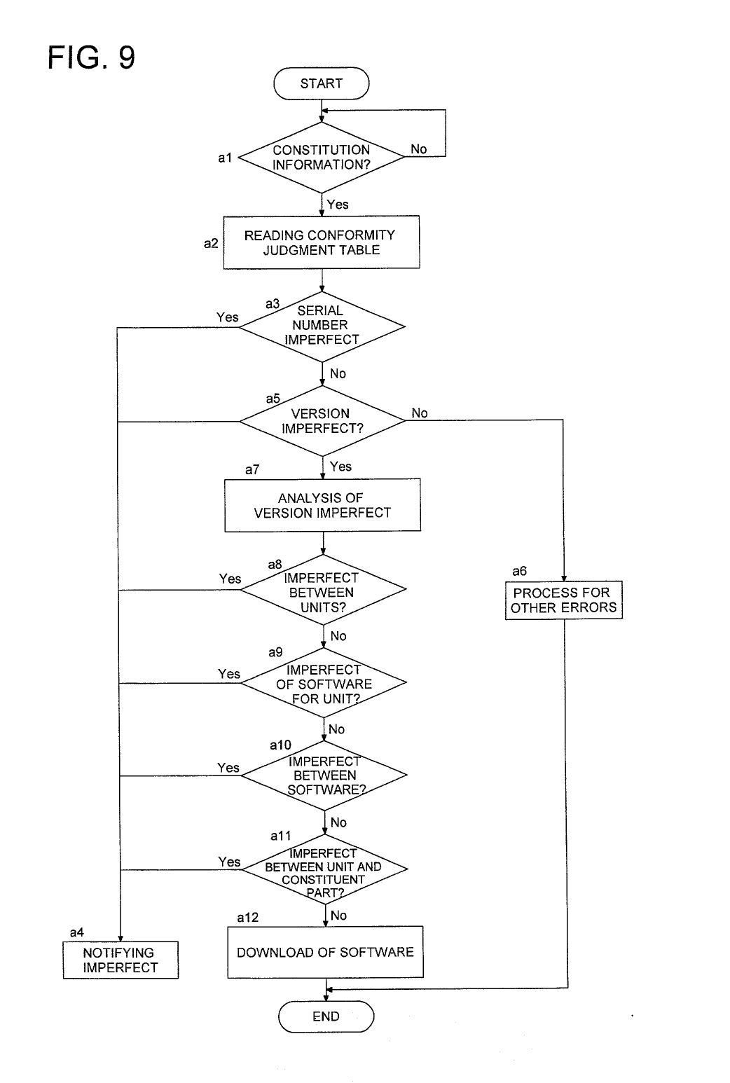

FIG. 9 is a flow chart showing operations for maintenance.

In step al, information is judged in monitoring center 201 whether the information is structure information from the image outputting apparatus 202 or not, and when the information is structure information, a compatibility judgment table is read for judging compatibility (step a2). In step a3, compatibility of the serial number is judged, and when the structure of the serial number is not described in the table in FIG. 8, the version is judged to be of an improper combination.

When compatibility is lost due to improper combination, an improper combination of the serial number is notified to image outputting apparatus 202 (step a4).

In step a5, when compatibility of the serial number of each unit is kept not to be improper combination, compatibility of software version installed is judged. First, when the software version is not described in the table in FIG. 8, processing for other errors is conducted to end under the assumption of no improper combination. (step a6).

When the software version is described in the table in FIG. 8, an improper combination of the software version is analyzed under the assumption that the software version is an improper combination (step a7), then, software between units is judged whether it is an improper combination or not, first, and a flow moves to step a4 when software between units is an improper combination (step a8).

When the software between units is not an improper combination, a unit and its corresponding software are judged to be of an improper combination or not in step a9, and a flow moves to step a4 in the case of an improper combination between the unit and its corresponding software.

In the case of no improper combination between the unit and its corresponding software, an improper combination between software is judged to exist or not, and a flow moves to step a4 in the case of an improper combination between software.

In the case of no improper combination between the unit and the corresponding software, an improper combination between the unit and supplies is judged to exist or not, and a flow moves to step a4 in the case of an improper combination between the unit and supplies.

In the case of no improper combination between the unit and supplies, the software is downloaded in step a12.

By judging compatibility for image outputting apparatus 202, image inputting unit 221, exposure unit 222 and print unit 223, or compatibility for plural image inputting units 221, exposure units 222 and print units 223 based on the structure information as stated above, it is possible to improve efficiency of maintenance.

As stated above, when compatibility of software version of image outputting apparatus 202 or of each unit such as image inputting unit 221, exposure unit 222 and print unit 223 is not kept, it is possible for monitoring center 201 to download a software version which is appropriate for the state of the image outputting apparatus 202 or of each unit to the storage section in the image outputting apparatus 202 or in each unit, and thereby to conduct maintenance automatically.

As a result of the operations mentioned above, a person who conducts maintenance can learn the structure information of image outputting apparatus 202 before visiting the location where the image outputting apparatus 202 is installed, which makes the maintenance to be efficient. In addition, when improper combination of a version can be solved by version-upgrading of software, it is possible to solve the improper combination of a version of the software easily, because necessary software is downloaded from monitoring center 201.

When compatibility of structure of image outputting apparatus 202 or of each unit is not kept, monitoring center 201 may also notify and select appropriate structure by notifying to the image outputting apparatus 202 or to each unit.

Further, it is possible to judge compatibility between a certain software and another software, or compatibility between each unit and software, by judging compatibility of image outputting apparatus 202 based on structure information that includes specific ID information corresponding to software or information specifying a preparer and version information.

Based on structure information that includes specific ID information or information specifying a preparer, the monitoring center may judge whether compatibility for each unit and software or for both of them is kept or not, and thereby, switch a unit or software of the image outputting apparatus, or change automatic version.

In the invention with each of structures (6)-(8), a person who conducts maintenance can be free from visiting the location for installation of an image outputting apparatus again after obtaining a necessary unit and software, as stated above. Thus, efficiency of maintenance can be improved.

Next, an embodiment for an image outputting apparatus that attains the third object administrating system will be explained as follows, referring to FIG. 6 and FIG. 7.

In the present embodiment, in the structure diagram in FIG. 7, control unit 220 is provided with CPU 220a and memory 220b, and software is installed in the memory 220b and the CPU 220a executes the software to conduct desired operations through the control. The control unit 220 stores a history of errors generated in image outputting apparatus 202 in the internal memory 220b, and this information to be stored is called “error log information”.

The log, in this case, is one wherein information showing the state of operation of the image outputting apparatus is described with time and code, and the log is added, eliminated and updated gradually.

Examples of log generated between control unit (CP) and film scanner unit (FS) that constitutes image inputting unit 221 are shown below.

2000/05/06 00:10:20.00 CP-FS:NT00000

No abnormality in communication between CP and FS

2000/05/06 00:10:25.00 CP-FS:WA00001

Warning of code 00001 in communication between CP and FS

2000/05/06 00:10:30.00 CP-FS:SE00001

Serious error of code 00001 in communication between CP and FS

2000/05/06 00:10:30.30 FS:SE00007

Serious error code 00007 in FS unit

In the foregoing, the first term represents year, month and day, and next term represents time. (o'clock, minute and second).

The next term represents communication and its related matters, and CP-FS represents data transmission from a control unit to a film scanner unit. Those after a colon represent the state of the control unit and the film scanner unit such as NT (no trouble), WA (warning), ER (error) and SE (serious error), and a number of five figures in the last term represents a location and contents of occurrence.

For example, NT00000 shows no troubles, NT00001 shows under scanning, and NT00002 shows under conveyance, while, WA00001 shows a slight problem in scanning, and ER00001 shows suspension due to a serious problem such as a jam. SE00001 can be defined as an occasion where signal input for the state of scanning cannot be obtained. Incidentally, it is also possible to detect troubles of an image outputting apparatus, depending on generated code.

Image inputting unit 221 is provided with CPU221a and memory 221b, while, exposure unit 222 is provided with CPU223a and memory 223b, and print unit 223 is provided with CPU222a and memory 222b. In each of memories 221b, 222b and 223b, there is installed software, and each of CPUs 221a, 222a and 223a executes the software to conduct desired operation through the control.

In the present embodiment, each of the image inputting unit 221, the exposure unit 222 and the print unit 223 is provided with a CPU and a memory. However, there is also an occasion wherein a CPU and a memory are not provided, and a control is made by a software for total control by means of CPU 220a and memory 220b both provided on the control unit 220.

The monitoring center 201 in the embodiment has control unit 210. The control unit 210 is controlled by a software for the total control by CPU 210a and memory 210b.

On each of control unit 210 of monitoring center 201 and control unit 220 of image outputting apparatus 202, there are provided communication means 210c and 220c which are connected to network 203, and the communication means 210c and 220c are used to conduct communication between monitoring center 201 and image outputting apparatus 202.

Image outputting apparatus 202 has memory 220b that stores error log information, and monitoring center 201 judges occurrence of troubles of the image outputting apparatus 202 based on error log information obtained from the image outputting apparatus 202 through communication, and thus, it is possible, when conducting remote maintenance, to conduct maintenance wherein the structure of each image outputting apparatus 202 and a history of errors of image outputting apparatus 202 up to the present time are taken into consideration.

Based on error information, monitoring center 201 changes, corrects or version-upgrades control software in image outputting apparatus 202 based on error log information, and conducts remote maintenance.

Image outputting apparatus 202 transmits to meet the request for periodic transmission of error log information from monitoring center 201, and obtains error log information periodically for reasons on the monitoring center side, thus, it can conduct remote maintenance.

Further, image outputting apparatus 202 can transmit to meet the request for transmission of necessary error log information from monitoring center 201, and can obtain error log information promptly at need for reasons on the monitoring center 201 side, thus, it can conduct remote maintenance.

In addition, image outputting apparatus 202 may also transmit error log information periodically to monitoring center 201 independently of the request from monitoring center 201, and transmit error log information periodically to monitoring center 201 for reasons of image outputting apparatus 202, thus, remote maintenance can be conducted by monitoring center 201.

Further, image outputting apparatus 202 may also transmit error log information to monitoring center 201 at need independently of the request from monitoring center 201, and report error log information promptly to monitoring center 201, thus, remote maintenance can be conducted.

Image outputting apparatus 202 may further transmit to monitoring center 201 at the timing corresponding to content accumulation data for error log information, and it can report error log information promptly to monitoring center 201 when serious errors are caused to conduct remote maintenance.

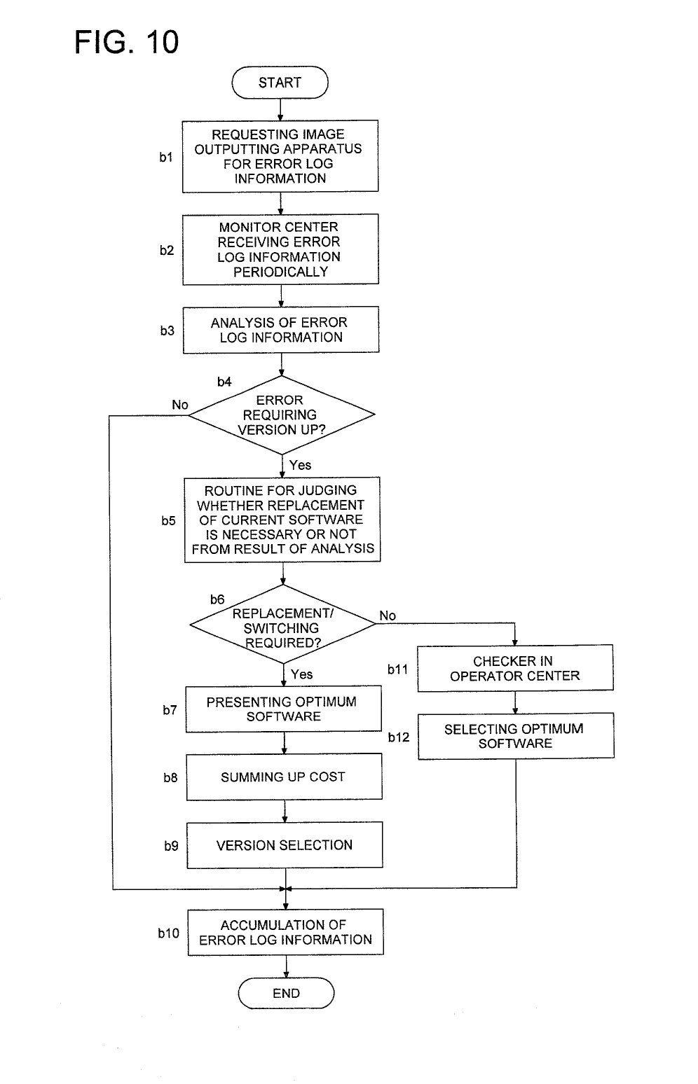

FIG. 10 is a flow chart showing periodical inspection operations of error log.

In step b1, monitoring center 201 periodically transmits messages which request error log information to image outputting apparatus 202. In step b2, image outputting apparatus 202 transmits error log information to monitoring center 201 through network 203, and the monitoring center receives the error log information.

In step b3, monitoring center 201 analyzes error log information, and in step b4, error is judged from error log information whether the error is on the level requiring version-upgrading of software or not, and when the error is found, processing goes to step b5.

In step b5, from the results of analyses of error log information, there is conducted judgment routine for whether replacement of current software is needed or not, and in step b6, it is judged whether replacement or switchover is needed or not. When replacement or switchover is needed, optimum software is exhibited in step b7, its cost is calculated in step b8, version selection is conducted (step b9), then, version is upgraded to the optimum software and error log information is accumulated (step b10).

In step b4, when an error is not found, the flow moves to step b10 to be ended.

When it is unclear whether replacement or switchover is needed or not, in step b6, monitoring center 201 indicates error log information found. An operator of the monitoring center 201 observes the indication and learns that an error is caused on prescribed image outputting apparatus 202 (step b11). The operator notifies contents of the error to the maintenance department, and the maintenance department selects the optimum software to repair image outputting apparatus 202 (step b12), and a flow moves to step b10 where error log information is accumulated.

The monitoring center 201 collects error log information periodically as stated above, resulting in that the monitoring center 201 learns a history of errors of image outputting apparatus 202.

In the present embodiment, it is possible to learn a troubled section of image outputting apparatus 202 by taking the errors which have caused in the image outputting apparatus 202 in the past into consideration, since error log information of the image outputting apparatus 202 is known. Further, in the case of frequent occurrence of the same errors, there is a possibility that previous repair was not carried out satisfactorily. Therefore, it is possible to judge that a method of repair needs to be reviewed.

With respect to the image outputting apparatus 202, it displays its own abnormality, because of ambient conditions, parts, and applications which vary depending on the location of installation and on a user for the image outputting apparatus 202. There is a possibility that some minilabs use processing agents which are not genuine or they use a print paper made by a different maker, resulting in the state of abnormality of this kind by monitoring center 201, and thereby, by changing or modifying a part of the current parts, application software or sequence software or by switching them to the software of a new version.

After finding out the real causes and grasping the situation by referring to the state of error log information and its history, a change is made to the optimum software. The change, modification, switching and upgrading of version for the software can be carried out through remote control operation.

Further, as a variation, it is preferable to make a computer, in place of a human, to obtain the actions to be taken based on the results of analyses of error log information.

In addition, though the present embodiment employs the structure wherein monitoring center 201 requests error log information periodically to image outputting apparatus 202, the image outputting apparatus 202 itself may also transmit error log information periodically to the monitoring center 201 independently, without waiting the request from the monitoring center 201.

It is further preferable that image outputting apparatus 202 reports occurrence of errors to monitoring center 201 at optional timing. For example, it is preferable that image outputting apparatus 202 reports immediately when it detects serious error independently.

First, conversion of the optimum software from error log information is presented by monitoring center 201, or a plurality of them can be presented together with cost. A compromising system wherein an operator of the monitoring center 201 or a user of the image outputting apparatus 202 determines finally is also possible.

As stated above, in the invention of structure (9), when executing remote maintenance for an image outputting apparatus in minilab and others, it is possible to make the maintenance wherein structure of each image outputting apparatus and a history of errors of the image outputting apparatus up to the current time are considered to be feasible.

What is claimed is:

1. An apparatus administrating system, wherein transmission and receipt can be carried out between at least one image outputting apparatus and an administrating apparatus to conduct maintenance administration of the image outputting apparatus, each function and unit which are necessary for operating the image outputting apparatus are controlled on a unification basis by communication between the administrating apparatus and the image outputting apparatus, the administrating apparatus acquires information of the function and unit of the image outputting apparatus through transmission and receipt with respect to updating of software that conducts control of operations of each function and unit of the image outputting apparatus, and software for plural image outputting apparatuses capable of operating under the appropriate conditions including, at need, the aforesaid image outputting apparatus are updated.

2. The apparatus administrating system according to claim 1, wherein abnormalities of each function and unit necessary for operating the image outputting apparatus are judged based on information of operations of the image outputting apparatus accumulated in the image outputting apparatus, and software for plural image outputting apparatuses capable of operating under the appropriate conditions including the aforesaid image outputting apparatus are updated.

3. The apparatus administrating system according to claim 1, wherein information obtained from the image outputting apparatus can be accumulated in the storage section of the administrating apparatus.

4. The apparatus administrating system according to claim 1, wherein information based on the aforesaid accumulated information are available from the image outputting apparatus.

5. The apparatus administrating system according to claim 1, wherein each function and each unit of the image outputting apparatus have specific symbols which can be discriminated respectively.

6. An image outputting apparatus administrating system in which a monitoring center and an image outputting apparatus having a plurality of units are connected by a network and the image outputting apparatus is administrated by the monitoring center, wherein the image outputting apparatus has a function to send structure information of plural units to the monitoring center, and the monitoring center has a function to judge compatibility between the image outputting apparatus and the unit, or compatibility among plural units, based on structure information coming from the image outputting apparatus.

7. The image outputting apparatus administrating system according to claim 6, wherein the structure information includes a serial number of each unit and a software version installed.

8. The image outputting apparatus administrating system according to claim 6, wherein the image outputting apparatus sends the structure information to the monitoring center when the image outputting apparatus is connected to the network.

9. The image outputting apparatus administrating system according to claim 6, wherein the image outputting apparatus sends the structure information to the monitoring center to meet the request from the monitoring center.

10. The image outputting apparatus administrating system according to claim 6, wherein the image outputting apparatus sends the structure information periodically to the monitoring center.

11. The image outputting apparatus administrating system according to claim 6, wherein the image outputting apparatus sends the structure information periodically to the monitoring center, as occasion demands.

12. The image outputting apparatus administrating system according to claim 6, wherein when compatibility of software version for the image outputting apparatus or for each unit is not kept, the image outputting apparatus makes the image outputting apparatus or each unit for which the compatibility is not kept to download the software version appropriated for the condition of the image outputting apparatus or each unit.

13. The image outputting apparatus administrating system according to claim 6, wherein when compatibility of structure for the image outputting apparatus or for each unit is not kept, the monitoring center notifies to the image outputting apparatus or to each unit.

14. The image outputting apparatus administrating system according to claim 13, wherein the monitoring center notifies to the image outputting apparatus or to each unit and selects appropriated structure to notify it.

15. The image outputting apparatus administrating system according to claim 6, wherein the image outputting apparatus has a function to send specific ID information corresponding to software installed in the image outputting apparatus or structure information including preparer specifying information and version information to the monitor center, and the monitoring center has a function to judge compatibility of the image outputting apparatus based on structure information coming from the image outputting apparatus.

16. The image outputting apparatus administrating system according to claim 6, wherein the image outputting apparatus has a function to send specific ID information corresponding to plural units and plural software or structure information including preparer specifying information and version information to the monitor center, and the monitoring center has a function to judge, based on structure information coming from the image outputting apparatus, whether compatibility between each unit and software or compatibility among them is kept or not, and unit or software of the image outputting apparatus is switched or an automatic version is changed based on the judgment stated above.

17. An image outputting apparatus administrating system in which a monitoring center and an image outputting apparatus are connected by a network and the image outputting apparatus is administrated by the monitoring center, wherein the image outputting apparatus has a memory with which the image outputting apparatus stores error log information, and the monitoring center judges occurrence of troubles of the image outputting apparatus based on error log information obtained from the image outputting apparatus.

18. The image outputting apparatus administrating system according to claim 17, wherein the monitoring center conducts change, correction or version upgrading for the control software in the image outputting apparatus, based on the error log information.

19. The image outputting apparatus administrating system according to claim 17, wherein the image outputting apparatus transmits to meet the request by the monitoring center for sending periodic error log information.

20. The image outputting apparatus administrating system according to claim 17, wherein the image outputting apparatus transmits to meet the request made, at need, by the monitoring center for sending error log information.

21. The image outputting apparatus administrating system according to claim 17, wherein the image outputting apparatus transmits error log information periodically to the monitoring center.

22. The image outputting apparatus administrating system according to claim 17, wherein the image outputting apparatus transmits error log information to the monitoring center as occasion demands.

23. The image outputting apparatus administrating system according to claims 17, wherein the image outputting apparatus transmits to the monitoring center at the timing corresponding to the accumulation data for contents of error log information.
